(19) United States
(12) Patent Application Publication
(10) Pub. No.: US 2025/0335194 A1
(43) Pub. Date: Oct. 30, 2025

(54) ASSESSING SOFTWARE RELIABILITY USING A REPUTATION GRAPH

(71) Applicant: Stacklok, Inc., Seattle, WA (US)

(72) Inventors: Craig McLuckie, Seattle, WA (US); Pankaj Telang, Cary, NC (US); Luke Hinds, Chippenham (GB); Nigel Brown, Devon (GB)

(21) Appl. No.: 18/649,587

(22) Filed: Apr. 29, 2024

(51) Int. Cl. G06F 8/77; G06F 8/71

(52) U.S. Cl. CPC G06F 8/77; G06F 8/71

(57) ABSTRACT

Techniques for assessing software reliability using a reputation graph are disclosed. A package for which to determine a reputation score is identified. Then, a package activity score is computed based on one or more package attributes. The one or more package attributes may include a number of downloads for the package or a quantity of positive feedback for the package. A repository associated with the package is identified. A repository reputation score is obtained for the repository. A package reputation score is determined based on the package activity score and the repository reputation score. The package reputation score is then presented to a user.

### BACKGROUND

Open-source software is software the public may use, modify, or distribute. Open-source software can be released in two different forms: (1) source code in which the software is originally authored; or (2) executable code by which the software can be executed. It is common for those responsible for creating open-source software to release its source code in a source code repository such as GitHub. Developers or others can then release executable code for the open-source software that is based on this source code as a package via a package repository such as PyPI or Maven. The package can in turn be incorporated into various software projects to provide various functionalities.

For example, a first open-source project may be developed in the C++ programming language, and its source code released in a source code repository. The creators or others can compile this C++ source code to obtain a binary executable and release the binary executable in a package repository. Others can download the binary executable from the package repository and incorporate it into a software project.

### BRIEF DESCRIPTION OF THE DRAWINGS

FIG. 1 is a block diagram showing some of the components typically incorporated in at least some of the computer systems and other devices on which the facility operates.

FIG. 2 is a graph diagram showing a sample reputation graph depicting relationships between contributor reputation scores, a repository reputation score, and a package reputation score in accordance with the facility.

FIG. 3 is a flow diagram showing a process performed by the facility in some embodiments to calculate a repository reputation score using a reputation graph.

FIG. 4 is a flow diagram showing a process performed by the facility in some embodiments to calculate a contributor reputation score using a reputation graph.

FIGS. 5A and 5B are reputation graph diagrams illustrating reputation propagation between repositories and contributors in accordance with the facility.

FIG. 6 is a flow diagram showing a process performed by the facility in some embodiments to calculate a package reputation score using a reputation graph.

FIGS. 7A and 7B are reputation graphs illustrating reputation propagation between a repository and a package in accordance with the facility.

### DETAILED DESCRIPTION

Selecting an open-source software package to incorporate into a software project is often an important step in software development. A software project incorporating a package is typically built to interact with various aspects of the package. Therefore, once the software project incorporates the package, the package may be difficult to remove. If the package does not work as intended in the software project or is not properly maintained, the software project may be re-written at great expense to exclude the package, replace various functionality previously provided by the package, or fix problems caused by the package. Worse still, some packages contain malware that may harm computers that interact with the software project. Such risks highlight the importance of understanding a package's reputation before using it in a software project.

Despite widespread adoption of packages, the inventors have recognized that the failure of conventional techniques to assess packages' quality, authenticity, reliability, etc., represents a major disadvantage. In general, users make their own determinations as to whether a package is reliable or suitable for use. These determinations may be made based on word-of-mouth, online searches about the package, etc. As a result, conventional techniques often fail to provide information necessary to accurately assess the reliability of a package.

Another disadvantage of conventional techniques for assessing open-source software is that they ignore the reliability of the repository where the source code is stored. Thus, users may download packages produced from low-quality source code repositories, again jeopardizing their software projects. The difficulty of assessing the reliability of a person who contributes source code to a repository (a “contributor”) is yet another disadvantage of conventional software assessment techniques. Thus, open-source project owners may inadvertently allow malicious or unskilled contributors to contribute source code to a repository, lowering source code and package quality. This diminishes the quality and quantity of software produced.

In response to recognizing these disadvantages, the inventors have conceived and reduced to practice a software and/or hardware facility for evaluating software using a reputation graph (“the facility”). Reliabilities of open-source packages, repositories, and contributors are determined such that users may easily identify reputable software. The facility identifies a package for which to determine a package reputation score. Then, the facility computes a package activity score based on one or more package attributes. In some embodiments, the one or more package attributes include a number of downloads of the package or a quantity of positive feedback for the package. The facility then determines a repository associated with the package and obtains a repository reputation score for the repository. The package reputation score is then calculated based on the package activity score and the repository reputation score. The package reputation score is then presented to a user in response to a user query.

In some embodiments, the package reputation score is calculated based on the repository reputation score, a measure of likelihood that the package contains source code from the repository, and the package activity score.

In some embodiments, the facility calculates the repository reputation score using a contributor reputation score. The contributor reputation score is calculated based on a contributor activity score and repository reputation scores of repositories to which the contributor has contributed.

In some embodiments, the package reputation score is presented to a developer. The package reputation score may be displayed, such as in an interactive user interface showing a reputation graph, with other information about the package.

In some embodiments, an open-source repository owner specifies a threshold contributor reputation score to be satisfied by a potential contributor to the open-source repository.

In some embodiments, an employer specifies a threshold contributor reputation score to be satisfied by a software development job candidate.

By performing in some or all of the ways described above, the facility determines software reputation using a reputation graph, enabling users to create more reliable software and reducing time and computing resources dedicated to running and maintaining unreliable software. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by determining a reputation of open-source software, the facility may prevent incorporation of disreputable open-source software into software projects. This reduces processor cycles used to execute deficient open-source software. Furthermore, the facility reduces processor cycles used to display an integrated development environment and receive inputs from a developer to fix various source code issues stemming from use of a deficient package. The saved processor cycles may then be deployed for other purposes, improving the functioning of computers.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

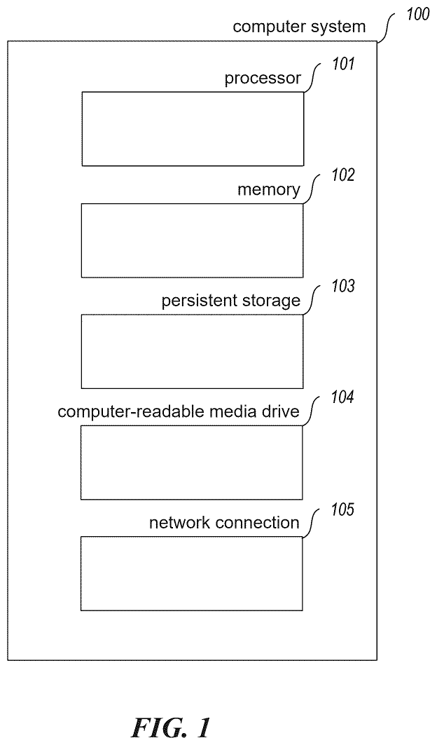

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc. —for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

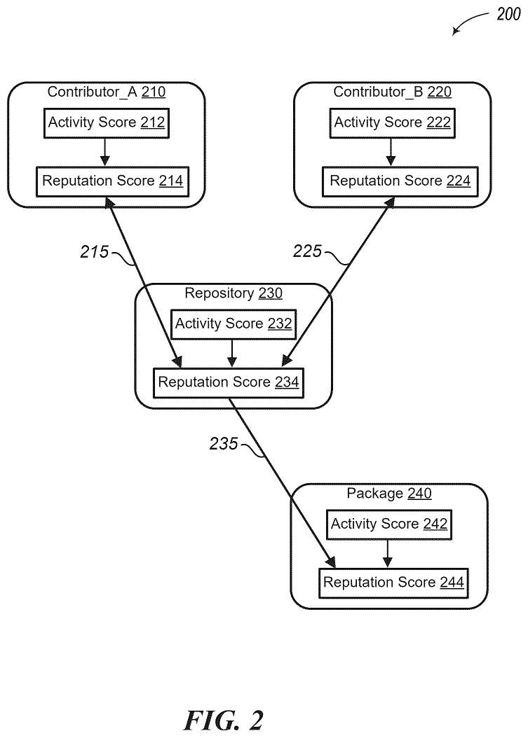

FIG. 2 is a graph diagram 200 showing a sample reputation graph depicting relationships between contributor reputation scores, a repository reputation score, and a package reputation score in a reputation graph in accordance with the facility. The example reputation graph 200 includes nodes contributor_A 210, contributor_B 220, repository 230, and package 240. Contributor_A 210 and contributor_B 220 contribute source code to repository 230, and package 240 is produced using source code in repository 230.

In various embodiments, the reputation graph includes nodes for contributors, repositories, and packages. In some embodiments, each node in the reputation graph includes an activity score and a reputation score, both of which can be displayed to users. The activity score is calculated using various attributes of a node. In some embodiments, the activity score is not directly exposed to users. The activity score is used to calculate the reputation score, which is exposed to users as representative of a contributor, repository, or package's reputation. The activity score of a node is used in combination with one or more reputation scores of one or more related nodes to generate a reputation score for the node.

Edges between two nodes in the reputation graph indicate a relationship between the two nodes such that a reputation score of one node affects the reputation score of the other node. An edge between a contributor node and a repository node, such as edge 215 or edge 225, indicates that the contributor has contributed to the repository. An edge between a repository and a package, such as edge 235, indicates that the package claims to be derived from source code in the repository. In some embodiments, edges between two packages indicate a dependency between a first package and a second package.

In some embodiments, edges between repository nodes and package nodes are directed such that the repository reputation score affects the package reputation score but the package reputation score does not affect the repository reputation score. For example, edge 235 from reputation score 234 to reputation score 244 indicates that reputation score 234 affects reputation score 244, but reputation score 244 does not directly affect reputation score 234.

In some embodiments, edges between contributor nodes and repository nodes are symmetrically directed such that contributor reputation affects repository reputation and vice-versa. For example, edges 215 and 225 are symmetrically directed, indicating that reputation scores 214 and 224 affect reputation score 234 and vice-versa.

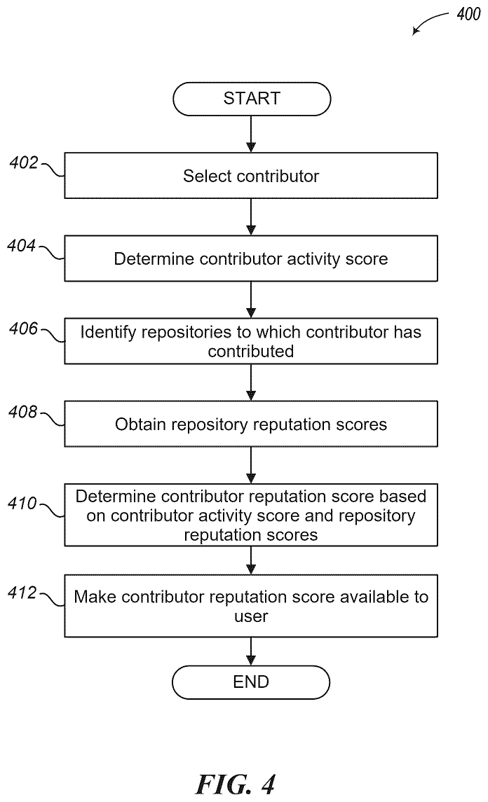

Contributor_A 210 is a node that represents a contributor who has contributed source code to a repository. Because contributor_A 210 is a node that represent a contributor, various characteristics of the contributor are used to calculate activity score 212. In various embodiments, the facility generates activity score 212 by performing a dimensionality reduction technique to information associated with the contributor. For example, the facility in various embodiments generates activity score 212 using principal component analysis (PCA), an autoencoder, a locally-linear embedding, a self-organizing map, a generative topographic mapping, etc. Generating the contributor activity score is described in detail with respect to FIG. 4.

In the example shown in FIG. 2, contributor_A 210 has contributed source code to repository 230 as indicated by edge 215. In this example, edge 215 is a symmetrically directed edge. Thus, reputation score 214 and reputation score 234 affect each other. Reputation score 234 of repository 230 is used in combination with activity score 212 to calculate reputation score 214. In various embodiments, the facility calculates reputation score 214 using activity score 212 and reputation score 234 as operands for addition, multiplication, linear combination, etc. In some embodiments, the facility calculates reputation score 214 using activity score 212 and reputation score 214, or a combination thereof, as input to a reputation propagation algorithm. In general, the facility may use any combination of activity score 212 and reputation score 234 to generate reputation score 214.

Contributor_B 220 is in various embodiments similar to contributor_A 210. The facility in various embodiments employes techniques described with respect to activity score 212 to generate activity score 222, and employs techniques similar to those described with respect to reputation score 214 to generate reputation score 224.

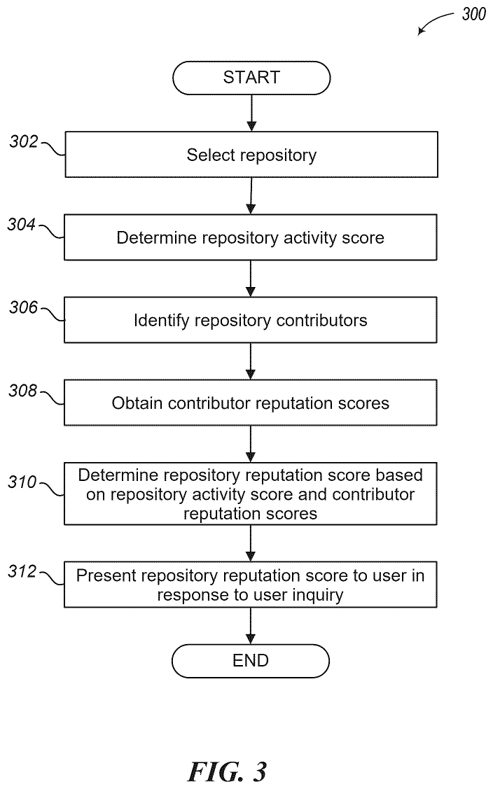

Repository 230 is a node that represents a source code repository. In the example shown in FIG. 2, contributor_A 210 and contributor_B 220 have contributed source code to repository 230, as indicated by edges 215 and 225, respectively. Because repository 230 is a node that represents a repository, various characteristics of the repository are used to calculate activity score 232. In various embodiments, the facility employs techniques similar to those described with respect to reputation score 214 to generate reputation score 234. Calculating a repository activity score is described in detail with respect to FIG. 3.

Package 240 is a node that represents a package that is represented as derived from a repository. In the example shown in FIG. 2, package 240 is represented as derived from repository 230, as indicated by edge 235. In the example shown in FIG. 2, edge 235 is directed from reputation score 234 to reputation score 244, indicating that reputation score 234 is used to calculate reputation score 244 while reputation score 244 is not used to calculate reputation score 234.

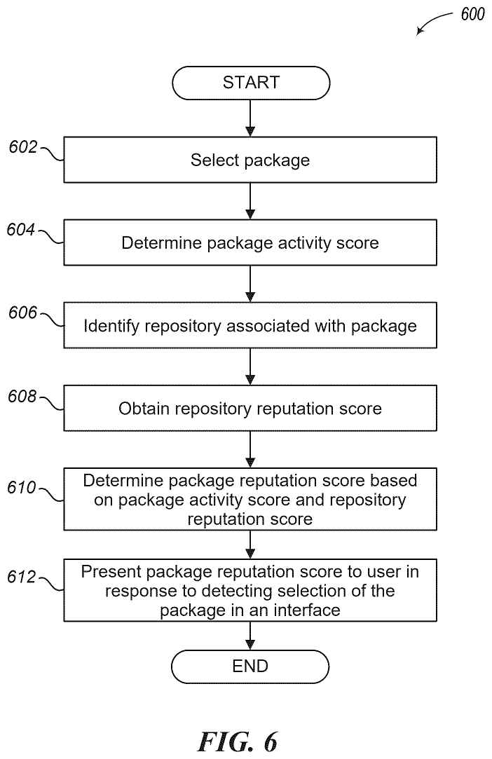

Because package 240 is a node that represents a package, various characteristics of the package are used to calculate activity score 242. In various embodiments, the facility employs techniques similar to those described with respect to reputation score 214 to generate reputation score 244. Determining a package activity score is described in detail with respect to FIG. 6.

In some embodiments, calculating reputation scores of nodes in the reputation graph is done in response to the facility detecting that package activity score 242 is to be updated. Package activity score 242 may be updated, for example, when package 240 is newly detected and does not yet have a package activity score 242. In some embodiments, the package score is updated every day, two days, week, month, etc. When the package score is updated, the facility in some embodiments recursively calculates activity scores, reputation scores, or a combination thereof, to be used to calculate the package score. For example, package reputation score 244 is calculated using package activity score 242 and repository reputation score 234. Thus, the facility in some embodiments updates package activity score 242 and repository reputation score 234 to be used in updating package reputation score 244. Similarly, repository reputation score 234 is calculated using repository activity score 232, contributor_A reputation score 214, and contributor_B reputation score 224, so each of these scores may be updated.

Note that in typical embodiments, reputation graphs are far larger than the reputation graph depicted in FIG. 2. Typical reputation graphs contain tens of thousands, hundreds of thousands, or millions of nodes. As a result, recursively calculating reputation scores to generate a package score as described above such that nodes connected to package 240 by any number of edges are updated to calculate reputation score 244 will often be impractical. Thus, in various embodiments, a threshold reputation distance is set, whereby only nodes connected to the node to be updated by a number of edges less than the threshold reputation distance are updated. For example, if the threshold reputation distance is one and package 240 is the node to be updated, reputation score 234 may be used to calculate repository score 244. If the threshold reputation distance is two and package 240 is the node to be updated, reputation score 234, reputation 214, and reputation score 224 may be used to update package reputation score 244, and so on. In some embodiments, the threshold reputation distance is between 1 and 10.

In various embodiments, reputation propagation in a reputation graph is performed iteratively. For example, package reputation score 244 may be incrementally updated several times based on reputation scores of nearby nodes in reputation graph 200a. In some embodiments, reputation propagation is performed until a difference in reputation between an iteration and a subsequent iteration is less than a propagation stopping threshold. For example, if the propagation stopping threshold is 0.2, a package reputation after a first iteration is 7.0, and a package reputation after a second iteration is 7.1, reputation propagation ends because the difference in reputation is 0.1, which is below the propagation stopping threshold of 0.2. In some embodiments, reputation propagation is performed for a predetermined or configurable number of iterations.

While relationships between contributors, repositories, and packages are discussed herein in terms of a reputation graph for ease of discussion, the disclosure is not so limited. In various embodiments, any suitable data structure may be used to represent the relationships between contributors, repositories, and packages. For example, one or more tables, maps, etc. may be used to represent the relationships between contributors, repositories, and packages.

FIG. 3 is a flow diagram showing a process 300 performed by the facility in some embodiments to calculate a repository reputation score using a reputation graph. Process 300 begins, after a start block, at block 302, where the facility selects a repository for which to calculate a repository reputation score. As discussed herein, a repository score is in some embodiments calculated as part of a recursive calculation to determine a package reputation score for a package associated with the repository. For example, when a new package node is added to the reputation graph with an edge connecting it to the repository node, the facility calculates an activity score for the new package node. Then, to calculate the package reputation score, the facility selects the repository to calculate the repository reputation score. In some embodiments, the repository is selected in response to detecting that a threshold of time has elapsed since an activity score for a package associated with the open-source repository was last computed. In some embodiments, the facility selects the repository in response to receiving a query for a reputation score of the repository. In some such embodiments, the repository is selected in response to detecting that an amount of time that has elapsed since the reputation score was last updated exceeds an update threshold. For example, the facility may select the repository in response to receiving a query for the repository reputation score and detecting that the repository reputation score has not been updated within an update threshold such as two days. After block 302, process 300 continues to block 304.

At block 304, the facility determines a repository activity score. In various embodiments, the facility calculates the repository activity score based on one or more of the repository's characteristics such as a number of forks, number of “stars” or other quantity of positive feedback, age, number of contributors, other indications of popularity or longevity, etc. In some embodiments, the facility generates the repository activity score using principal component analysis (PCA), an autoencoder, a locally-linear embedding, a self-organizing map, a generative topographic mapping, etc. For example, the facility may perform PCA using a plurality of repository characteristics to generate the repository activity score.

The facility may, in calculating the repository activity score, normalize one or more of the repository characteristics by calculating a percentile value of the characteristic as compared to a population of repositories. For example, if an age of the repository is older than 90% of repositories in the population of repositories, the account age of the repository may be assigned a value of 0.90. In some embodiments, the repository characteristics are normalized into a range of [0,1]. The facility then, in some embodiments, provides the repository characteristics to a multilayer perceptron or other artificial intelligence model to generate the repository activity score. In some embodiments, the repository activity score is generated using a linear combination of one or more values corresponding to the repository characteristics. In various embodiments, the facility determines the repository activity score employing techniques similar to those described herein with respect to determining a contributor activity score or a package activity score. After block 304, process 300 continues to block 306.

At block 306, the facility identifies contributors to the repository. In some embodiments, the facility scrapes the repository to identify the contributors to the repository. In some embodiments, the facility uses an application programming interface of the repository to identify the contributors. In some embodiments, the facility identifies contributors by accessing a stored list of contributors to the repository in addition to, or instead of, scraping the repository or using an application programming interface. After block 306, process 300 continues to block 308.

At block 308, the facility obtains reputation scores for the identified contributors. In some embodiments, the facility obtains the reputation scores for the identified contributors by computing new reputation scores for the identified contributors. In various embodiments, the facility employs embodiments of process 400, described herein, to compute the new reputation scores for the identified contributors. In some embodiments, the facility obtains the reputation scores for the identified contributors by accessing saved reputation scores for the identified contributors. After block 308, process 300 continues to block 310.

At block 310, the facility determines the repository reputation score based on the repository activity score and the obtained contributor reputation scores. In some embodiments, the facility determines the repository reputation score by calculating a weighted combination of the repository activity score and each obtained contributor reputation score. For example, the repository reputation score may be a mean, median, or mode of the repository activity score and each obtained contributor score. In some embodiments, the repository reputation score is calculated using a current repository reputation score. For example, the repository reputation score may be calculated by combining a previous reputation score with the repository activity score and the each obtained repository score. In some such embodiments, the previous reputation score, the repository activity score, and each obtained contributor reputation score are each associated with weights that the facility uses to create a weighted combination of the scores for use in calculating the repository reputation score. In some embodiments, in calculating the repository reputation score, the facility weights each obtained contributor reputation score based on an attribute of one or more corresponding contributions of the contributor to the repository such as a recency, size, quantity, frequency, etc., of the one or more contributions. For example, a reputation score corresponding to a contributor who has contributed 80% of the source code to the repository may be weighted more than a reputation score for a contributor who has contributed 1% of the source code to the repository. In another example, a reputation score corresponding to a contributor who last contributed to the repository five years ago may be weighted less than a reputation score corresponding to a contributor who contributed to the repository yesterday. In various embodiments, the repository reputation score is determined by providing the contributor reputation scores, the repository activity score, and, in some embodiments, one or more weights corresponding to the contributor reputation scores to an artificial intelligence model. After block 310, process 300 continues to block 312.

At block 312, the facility presents the repository reputation score to a user in response to a user inquiry. In some embodiments, the user inquiry is an explicit query to a data structure containing one or more repository reputation scores. In some embodiments, the facility automatically generates the user query based on one or more actions of the user. For example, the facility in some embodiments generates a query for a repository reputation score in response to detecting that a user has navigated to a webpage associated with the repository. The score is then presented in a pop-up window, as a browser extension icon, in an operating system taskbar, or as a phone or email notification, etc. In some embodiments, the user may configure notifications so that, for example, the user only receives a notification when the repository score is below a specified or predetermined threshold. After block 312, process 300 ends at an end block.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 4 is a flow diagram showing a process 400 performed by the facility in some embodiments to calculate a contributor reputation score using a reputation graph.

Process 400 begins, after a start block, at block 402, where the facility selects a contributor for which to determine a contributor reputation score. As discussed herein, a repository reputation score is calculated using one or more contributor reputation scores. Thus, in some embodiments, the facility selects the contributor when a reputation score of a repository that the contributor has contributed to is being updated. In some embodiments, the facility selects the contributor in response to receiving a query for the contributor reputation score. After block 402, process 400 continues to block 404.

At block 404, the facility determines a contributor activity score for the contributor. In various embodiments, the facility calculates the contributor activity score based on one or more of the contributor's attributes such as a number of followers of the contributor, a quantity of code the contributor has successfully contributed to repositories, an age of the contributor's account, a count of repositories the contributor has contributed to, an account ban history of the contributor, etc. In various embodiments, the facility calculates the contributor activity score employing embodiments of block 304 of FIG. 3. After block 404, process 400 continues to block 406.

At block 406, the facility identifies repositories to which the contributor has contributed source code. In some embodiments, the facility identifies the repositories by scraping a repository hosting website for repositories associated with the contributor. In some embodiments, the facility identifies the repositories using an application programming interface for the repository hosting website. The facility in some embodiments identifies the repositories by accessing a data structure that includes repositories associated with the contributor. After block 406, process 400 continues to block 408.

At block 408, the facility obtains repository reputation scores for the identified repositories. In various embodiments, the facility obtains the repository reputation scores by computing new repository reputation scores for the identified repositories. In various embodiments, the facility employs embodiments of process 300 of FIG. 3 to compute the repository reputation scores. In some embodiments, the facility obtains the repository reputation scores by accessing stored repository reputation scores for the selected repositories. After block 408, process 400 continues to block 410.

At block 410, the facility determines a contributor reputation score based on the contributor activity score and the repository reputation scores. In various embodiments, the facility employs techniques similar to those discussed with respect to block 310 of FIG. 3 to determine the contributor reputation score. After block 410, process 400 continues to block 412.

At block 412, the facility makes the contributor reputation score available to an owner of a repository for which the contributor has proposed source code to contribute. In some embodiments, the facility makes the contributor reputation score available to the owner of the repository by employing techniques similar to those described with respect to block 312 of FIG. 3. For example, the facility may make the contributor reputation score available to the owner of the repository using a notification, pop-up window, etc.

In some embodiments, the facility makes the contributor reputation score available to an employer. For example, an employer attempting to fill a developer job opening may specify a threshold contributor reputation score for job candidates to be considered for the job opening. The, the facility makes the contributor reputation score available to the employer if the contributor reputation score exceeds the threshold contributor reputation score.

In various embodiments, the facility makes the contributor reputation score available to an academic journal, professional organization, or other organization. In some embodiments, the facility makes the contributor reputation score publicly available. After block 412, process 400 ends at an end block.

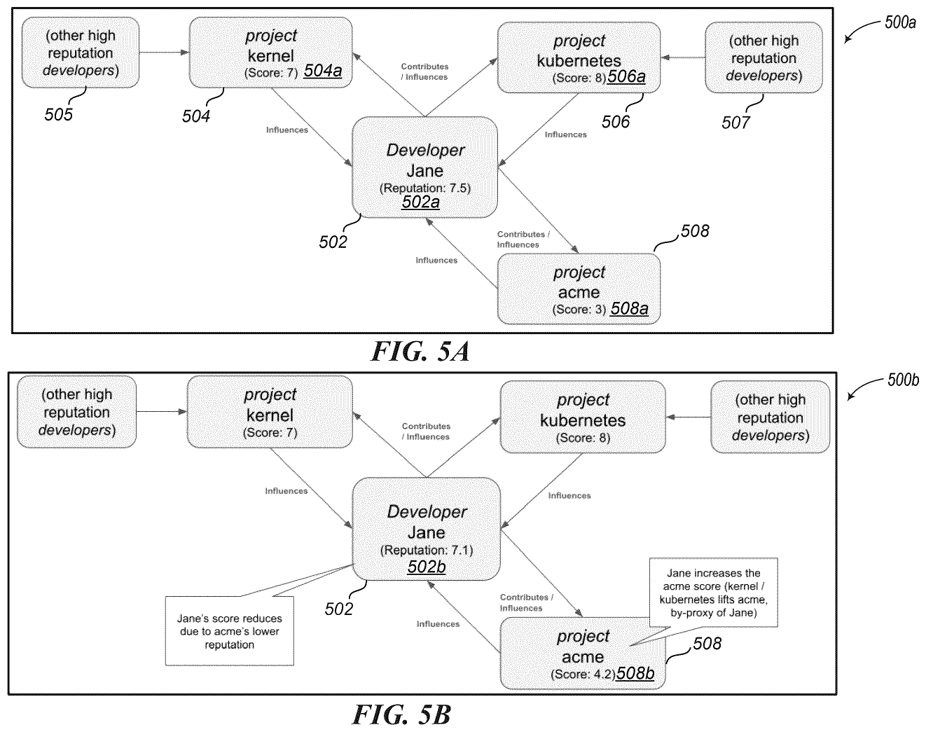

FIGS. 5A and 5B are reputation graph diagrams illustrating reputation propagation between repositories and contributors in accordance with the facility.

FIG. 5A shows a reputation graph 500a before reputation propagation between a repository and a contributor. Reputation graph 500a includes contributor nodes developer Jane 502, developers_A 505, and developers_B 507. Reputation graph 500a also includes repository nodes 504, 506, and 508. In the example shown in reputation graph 500a, prior reputation score 502a of developer Jane 502 has not been updated to reflect a contribution to project acme 508 by developer Jane 502. Because there is now an edge from project acme 508 to developer Jane 502, and vice versa, a next calculation of prior reputation score 502a, currently 7.5, and prior reputation score 508a, currently 3, will reflect the new relationship between developer Jane 502 and project acme 508.

FIG. 5B shows a reputation graph 500b after reputation propagation between developer Jane 502 and project acme 508. To account for developer Jane 502's new relationship with project acme 508, the facility computes updated reputation score 502b and updated reputation score 508b. Whereas before propagation, developer Jane 502 had prior reputation score 502a of 7.5, updated reputation score 502b is 7.1, reflecting developer Jane 502's relationship with lower-reputation project acme 508, which had a prior reputation score 508a of 3. But project acme 508's updated reputation score 508b increased to 4.2, reflecting project acme 508's relationship with higher-reputation developer Jane 502.

In some embodiments, an updated reputation score is calculated based on a prior reputation score. For example, updated reputation score 502b may be calculated using prior reputation score 502a. In some embodiments, edges in the reputation graph are weighted and each edge weight of an incoming edge is used to calculate the updated reputation score. For example, prior reputation score 502a is in some embodiments combined with an edge weight corresponding to an incoming edge to project acme 508 from developer Jane 502 to calculate project acme's updated reputation score 508b.

FIG. 6 is a flow diagram showing a process 600 performed by the facility in some embodiments to calculate a package reputation score using a reputation graph.

Process 600 begins, after a start block, at block 602, where the facility selects a package for which to determine a reputation score. In some embodiments, the facility selects the package in response to detecting that a threshold period of time has elapsed since an activity score for the package has been calculated. For example, the facility in some embodiments updates the package activity score periodically at a specified interval such as a daily, weekly, monthly, etc. When the facility detects that the specified period, such as a week, has elapsed since the package activity score was last updated, the facility selects the package to compute a new activity score. In some embodiments, the facility selects the package in response to receiving a query for the package's reputation score. In some such embodiments, the facility selects the package to compute the reputation score if the time since the package activity score was last updated exceeds a threshold such as a day. After block 602, process 600 continues to block 604.

At block 604, the facility determines a package activity score. In various embodiments, the facility calculates the package activity score based on one or more package attributes such as the package's age, a number of versions released, a number of downloads, other indications of the package's popularity or longevity, etc. In various embodiments, the package activity score is calculated using one or more of the package attributes according to techniques for calculating activity scores described herein. After block 604, process 600 continues to block 606.

At block 606, the facility identifies a repository associated with the package. In various embodiments, the facility identifies the repository associated with the package by retrieving information from a package repository that hosts the package. In various embodiments, the facility employs techniques similar to those described herein with respect to identifying contributors or repositories. After block 606, process 600 continues to block 608.

At block 608 the facility obtains a reputation score for the identified repository. In some embodiments, the facility obtains the reputation score for the identified repository by employing embodiments of block 408 in FIG. 4. After block 608, process 600 continues to block 610.

At block 610, the facility determines a package reputation score based on the package activity score and the repository reputation score. In some embodiments, the facility calculates the package reputation score using a linear combination of the package activity score and the repository reputation score. In some embodiments, the facility determines the package reputation score by assessing a relationship quality between the package and the repository. For example, if the package is unlikely to be based on source code from the repository, a contribution of the repository reputation score in calculating the package reputation score may be reduced. In some embodiments, the relationship quality is assessed by comparing metadata associated with the package to metadata associated with the repository. For example, the facility may compare a version number of the package to a tag of the repository to determine whether the version matches the tag, indicating that the package corresponds to the repository. In various embodiments, the facility determines the package reputation score by employing techniques similar to those described herein with respect to determining a contributor or repository reputation score.

In some embodiments, the package is dependent on one or more dependency packages. The dependency packages may also include dependencies on other packages, and so on. In some embodiments, the facility obtains dependency package reputation scores for the one or more dependency packages and determines the package reputation score based on the dependency package reputation scores. In some embodiments, a maximum reputation propagation distance is specified, such that reputation scores of packages a number of edges greater than the maximum reputation propagation distance are not used to determine the package reputation score. For example, if the maximum reputation propagation distance is 1, only reputation scores corresponding to packages and repositories having an outgoing edge to the package are used to determine the package reputation score. After block 610, process 600 continues to block 612.

At block 612, the facility presents the package reputation score to a user in response to detecting selection of the package in a user interface. In some embodiments, the facility presents the package reputation score to the user by employing techniques similar to those described with respect to block 312 of FIG. 3. For example, the facility may present the package reputation score to the user using a notification, pop-up window, etc. After block 612, process 600 ends at an end block.

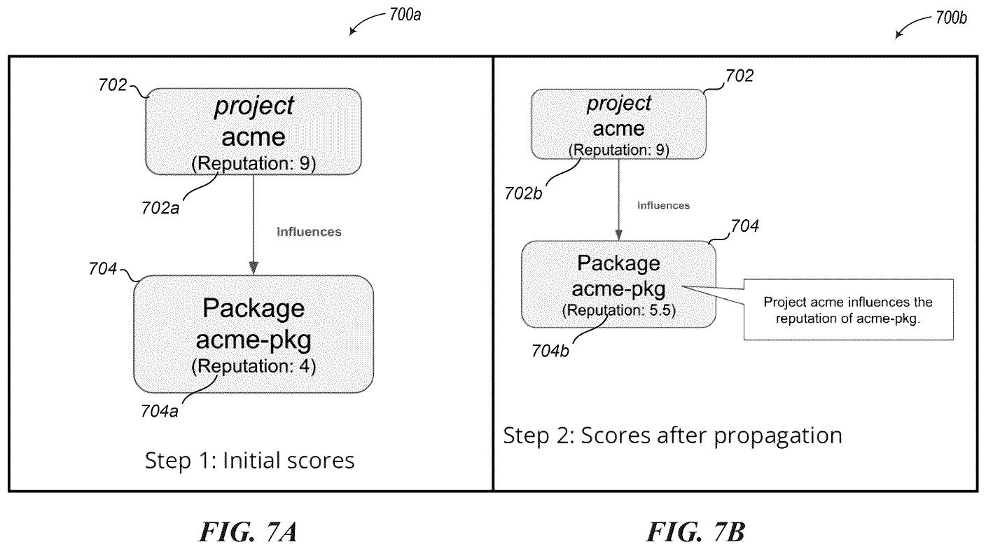

FIGS. 7A and 7B are reputation graphs illustrating reputation propagation between a repository and a package in accordance with the facility.

FIG. 7A shows a reputation graph 700a illustrating reputation propagation between a repository and a package associated with the repository. Reputation graph 700a includes repository 702 and package 404. In the example shown in reputation graph 700a, prior package reputation score 704a, with a value of 4, has not yet been updated to reflect a relationship with repository 702. Prior repository reputation score 702a has a value of 9. Because there is an edge from repository 702 to package 704, a next calculation of a package reputation score for package 704 will reflect the relationship between repository 702 and package 704. But because the edge is not symmetrical, the repository reputation score will not be changed by the relationship with package 704.

FIG. 7B shows a reputation graph 700b after reputation propagation between repository 702 and package 704. To account for the edge between repository 702 and package 704, the facility computes updated package reputation score 704b based on prior repository reputation score 702a. Because prior repository reputation score 702a has a value of 9 while prior package reputation score 704a has a value of 4, updated package reputation score has a value of 5.5. Note that updated repository reputation score 702b is the same as prior repository reputation score 702a because there is no directed edge from package 704 to repository 702.

In various embodiments, the updated package reputation score is calculated using embodiments similar to those discussed with respect to updated reputation score 502b in FIG. 5. For example, an influence of prior repository reputation score 702a on updated package reputation score is in some embodiments determined using a weight associated with an edge from repository 702 to package 704.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for assessing software reliability using a reputation graph, the method comprising:
identifying a package for which to determine a package reputation score;
determining a package activity score for the package based on one or more package attributes;
determining a repository associated with the package;
obtaining a repository reputation score for the repository;
determining a package reputation score based on the package activity score and the repository reputation score; and
presenting the package reputation score to a user.

2. The method of claim 1, wherein obtaining the repository reputation score comprises:
determining a repository activity score based on one or more repository attributes; and
determining the repository reputation score based on the repository activity score.

3. The method of claim 1, wherein obtaining the repository reputation score comprises:
determining a repository activity score based on one or more repository attributes;
identifying repository contributors who have contributed source code to the repository;
obtaining contributor reputation scores for each identified repository contributor; and
determining the repository reputation score based on the repository activity score and the contributor reputation scores.

4. The method of claim 3, wherein obtaining the contributor reputation scores for each identified repository contributor comprises:
selecting a contributor in the identified repository contributors;
determining a contributor activity score for the selected contributor based on one or more contributor attributes of the selected contributor;
identifying repositories to which the contributor has contributed source code;
obtaining repository reputation scores for each identified repository; and
determining a contributor reputation score based on the contributor activity score and the repository reputation scores.

5. The method of claim 3, wherein determining the repository reputation score comprises:
assessing a contribution weight for each contributor reputation score based on a characteristic of source code contributed to the repository by the contributor; and
determining the repository score based on a combination of the contributor reputation scores weighted by the contribution weights.

6. The method of claim 1, wherein identifying the package for which to determine the package reputation score comprises:
identifying the package in response to detecting that a threshold period of time has elapsed since an activity score for the package was last computed.

7. The method of claim 1, wherein identifying the package for which to determine the package reputation score comprises:
identifying the package in response to detecting that the package has been added to the repository.

8. The method of claim 1, wherein presenting the package reputation score to the user comprises:
in response to detecting that a page associated with the package is being displayed to a user, presenting the package reputation score to the user.

9. The method of claim 1, wherein identifying the package for which to determine the package reputation score comprises:
identifying a plurality of packages for which to determine package reputation scores; and
selecting the package from the plurality of packages.

10. The method of claim 1, wherein determining the package activity score comprises:
assessing a package attribute by applying principal component analysis (PCA) to information associated with the package; and
determining the package activity score based on the assessed package attribute.

11. The method of claim 1, wherein determining the package activity score for the package based on one or more package attributes comprises:
determining the package activity score based on a number of downloads of the package.

12. The method of claim 1, wherein determining the package activity score for the package based on one or more package attributes comprises:
determining the package activity score based on a quantity of positive feedback for the package.

13. A computing system for assessing software reputation using a reputation graph, the computing system comprising:
one or more processors; and
one or more computer-readable media configured to collectively store instructions that, when collectively executed by the one or more processors, cause the computing system to perform actions, the actions comprising:
selecting a contributor for which to determine a contributor reputation score;
determining a contributor activity score for the contributor based on one or more contributor attributes;
identifying repositories to which the contributor has contributed;
obtaining repository reputation scores for each identified repository;
determining a contributor reputation score based on the contributor activity score and the repository reputation scores; and
making the contributor reputation score available to an owner of a repository for which the contributor has proposed source code to contribute.

14. The computing system of claim 13, wherein selecting the contributor for which to determine the contributor reputation score comprises:
detecting that a threshold period of time has elapsed since an activity score for a package associated with a repository was last computed;
identifying one or more contributors to the repository; and
selecting the contributor from the one or more contributors to the repository.

15. The computing system of claim 13, wherein obtaining the repository reputation scores for each identified repository comprises:
selecting a repository in the identified repositories;
determining a repository activity score for the repository based on one or more repository attributes;
identifying contributors who have contributed to the repository;
obtaining contributor reputation scores for each identified contributor; and
determining a repository reputation score based on the repository activity score and the contributor reputation scores.

16. The system of claim 13, the actions further comprising:
obtaining, from an employer, a threshold contributor reputation score to be satisfied by employment candidates; and
in response to determining that the contributor reputation score satisfies the threshold contributor reputation score, providing the contributor reputation score to the employer.

17. One or more processor-readable storage media that store computer instructions that, when executed by one or more processors, cause the one or more processors to perform actions comprising:
selecting a package for which to determine a package reputation score;
determining a package activity score for the package based on one or more package attributes;
identifying a repository associated with the package;
obtaining a repository reputation score for the repository;
assessing a package reputation score based on the package activity score and the repository reputation score; and
in response to detecting selection of the package in an interface displayed to a user, presenting the package reputation score to the user.

18. The one or more processor-readable storage media of claim 17, wherein presenting the package reputation score to the user comprises:
determining one or more substitute packages that provide a functionality similar to at least one functionality of the package;
obtaining reputation scores for the substitute packages;
presenting, to the user, the reputation scores for the substitute packages and the package reputation score.

19. The one or more processor-readable storage media of claim 17, wherein selecting the package for which to determine the package reputation score comprises:
selecting the package in response to detecting that a threshold period of time has elapsed since an activity score has been determined for the package.

20. The one or more processor-readable storage media of claim 17, wherein assessing the package reputation score comprises:
identifying a dependency package on which the package depends;
obtaining a dependency package reputation score for the dependency package; and
assessing the package reputation score based on the package activity score, the repository reputation score, and the dependency package reputation score.
